(19) United States
(12) Patent Application Publication
(10) Pub. No.: US 2026/0256549 A1
(43) Pub. Date: Sep. 3, 2026

(54) BUCCAL TUBE AND METHOD FOR PROTECTING END OF ARCHWIRE

(71) Applicant: SHANGHAI STOMATOLOGICAL HOSPITAL (SHANGHAI STOMATOLOGIC HEALTH CENTER), Shanghai (CN)

(72) Inventors: Jie PAN, Shanghai (CN); Yuehua LIU, Shanghai (CN)

(73) Assignee: SHANGHAI STOMATOLOGICAL HOSPITAL (SHANGHAI STOMATOLOGIC HEALTH CENTER), Shanghai (CN)

(21) Appl. No.: 18/995,837

(22) PCT Filed: Feb. 18, 2024
(86) PCT No.: PCT/CN2024/077366

§ 371 Date: Jan. 17, 2025

(30) Foreign Application Priority Data
Apr. 3, 2023 (CN) 202310340647.8

(51) Int. Cl. A61C 7/28

(52) U.S. Cl. CPC A61C 7/282

(57) ABSTRACT

A buccal tube, includes a bottom plate fixed to the surface of an orthodontic tooth, a hollow arch tube for accommodating an arch wire therethrough, and an arch wire protection mechanism; when the buccal tube is mounted on a tooth of a patient, the arch wire protection mechanism is in a first state, and the arch wire protection mechanism covers the end of the arch wire passing through the hollow arch tube, so as to prevent the end of the arch wire from making contact with the oral mucosa of the patient; and before the buccal tube is mounted on the tooth of the patient, the arch wire protection mechanism is in a second state, and the passing of the arch wire in the hollow arch tube is not limited by the arch wire protection mechanism.

### TECHNICAL FIELD

The present application relates to the technical field of orthodontic medical devices, particularly to an orthodontic buccal tube and a method for protecting an end of an archwire.

### BACKGROUND

For existing dental braces, orthodontic devices are typically bonded to teeth using adhesives, and an archwire is placed in the orthodontic devices. After adjusting force, ends of the archwire should be cut short to expose as little as possible, or the ends of the archwire should be bent back and secured. However, both exposing the ends of the archwire and bending back the ends of the archwire to protect the mucosa have inevitable shortcomings:
1. Some patients have extremely sensitive oral mucosa, resulting in severe foreign body reactions to rough ends of the cut archwire, thus causing swelling and inflammation of the mucosa.
2. Bending the ends of the archwire is relatively easy when there is ample space in an oral cavity and the teeth in the mouth are sufficiently exposed. However, even under these favorable conditions, the high hardness of the archwire and the significant force required to bend back the ends of the archwire can easily lead to the detachment of bonded buccal tubes or improper bending, thus negatively affecting the orthodontic treatment effect or prolonging the orthodontic period.
3. For some patients with smaller oral cavities, the distal ends of the last corrected teeth may even be covered by the mucosa, which makes it very easy to damage the oral mucosa of the patients during the process of bending the ends of the archwire, and even in some cases, it may be impossible to bend the ends back at all.
4. The archwire that cannot be bent at the ends tends to slide within the oral cavity, potentially injuring surrounding mucosa tissues, and in severe cases, even leading to archwire breakage.
5. To control an optimal length for the ends bent back, a doctor often needs to spend some time adjusting the length of the archwire. This not only needs to prolong the operating time of the doctor but also requires repeatedly cutting and measuring the archwire in the oral cavity of the patient, which reduces the operational efficiency of the doctor and increases the time and number of times that the patient has to keep his or her mouth open during adjustments.
6. Some difficult end-bending operations can take up a lot of chairside operating time for the doctor and even bring great pain to the patient since the corners of the mouth need to be pulled to the limit, thus easily leading to injuries at the corners of the mouth of the patient.

For all these reasons, there is an urgent need to improve the ends of the buccal tube.

### SUMMARY

The technical problem addressed by this invention is to overcome the problem present in the prior art and to provide a buccal tube and a method for protecting an end of an archwire.

To solve the above problem, the technical solution of the present application is as follows:

A buccal tube includes a base plate fixed to a surface of an orthodontic tooth, a hollow archwire tube for accommodating an archwire to pass through, and an archwire protection mechanism.

When the buccal tube is mounted to a tooth of a patient, the archwire protection mechanism is in a first state, the archwire protection mechanism covers the end of the archwire passing through the hollow archwire tube, preventing the end of the archwire from coming into contact with an oral mucosa of the patient; and
before the buccal tube is mounted to the tooth of the patient, the archwire protection mechanism is in a second state, and the movement of the archwire in the hollow archwire tube is not restricted by the archwire protection mechanism.

The buccal tube further includes a traction hook arranged on the protection mechanism.

There is more than one hollow archwire tube.

The archwire protection mechanism is an openable and closable guard plate structure; when the archwire protection mechanism is in the second state, the guard plate structure is in an open state; and when the archwire protection mechanism is in the first state, the guard plate structure is in a closed state, and the guard plate structure covers the end of the archwire.

The openable and closable structure does not have a rotating shaft, and an archwire protective cover directly covers the end of the archwire and is secured.

The archwire protection mechanism is a protective cover structure, and the protective cover structure is pivotally secured to an outer wall of the hollow archwire tube or the base plate; when the archwire protection mechanism is in the second state, the protective cover structure is in an open state; and when the archwire protection mechanism is in the first state, the protective cover structure is in a closed state, and the protective cover structure covers the end of the archwire.

The protective cover structure is fixedly connected to the traction hook, and the protective cover structure and the traction hook are jointly and pivotally secured to the outer wall of the hollow archwire tube or the base plate; when the protective cover structure is in the second state, the protective cover structure is in an open state, a proximal wall of the traction hook abuts against the hollow archwire tube; when the archwire protection mechanism is in the first state, the protective cover structure is in a closed state, the protective cover structure covers the end of the archwire, and the end of the traction hook points to a distal side; and by toggling the traction hook, the archwire protection mechanism can be switched between the first and second states.

The protective cover structure is pivotally rotated through a rotating shaft arranged vertically, and the archwire protective cover is opened and closed left and right around the rotating shaft.

The protective cover structure is pivotally rotated through a rotating shaft arranged horizontally, and the archwire protective cover is opened and closed up and down around the rotating shaft.

The protective cover structure and the traction hook are fixedly and integrally formed, and the protective cover structure is in a cap shape.

The protective cover structure is a structure that can cover the entire hollow archwire tube and the end of the archwire passing therethrough.

A pivot is arranged on one side of the protective cover structure, the protective cover structure rotates and moves around the pivot, the pivot is located on the base plate, a hole for the archwire to pass through is formed in one side of the protective cover structure close to the pivot, and the other side of the protective cover structure is closed.

Provided is a method for protecting an end of an archwire. A buccal tube is provided with an archwire protection mechanism. When the buccal tube is mounted to a tooth of a patient, the archwire protection mechanism is in a first state, the archwire protection mechanism covers the end of the archwire passing through a hollow archwire tube, preventing the end of the archwire from coming into contact with an oral mucosa of the patient; before the buccal tube is mounted to the tooth of the patient, the archwire protection mechanism is in a second state, and the movement of the archwire in the hollow archwire tube is not restricted by the archwire protection mechanism.

A pivot is arranged on one side of the archwire protection mechanism, the archwire protection mechanism rotates and moves around the pivot, the pivot is located on a base plate, and a traction hook is further arranged on the archwire protection mechanism; and during use, the traction hook is turned to enable the archwire protection mechanism to rotate around the pivot, thereby covering the end of the archwire.

The archwire protection mechanism does not have a rotating shaft, and the archwire protection mechanism directly covers the base plate where the end of the archwire is located and is secured.

The beneficial effects: the buccal tube is provided with the archwire protection mechanism, which can perfectly cover the end of the archwire to prevent the end of the archwire from coming into contact with the oral mucosa, providing comfort to the patient; at the same time, the doctor can freely choose whether or not to bend the end during operating, for patients who do not require end bending, the archwire can be cut directly at one time and covered directly with the protective cover, without repeated adjustments; and for patients who must undergo end bending, the protective cover will not affect the operation of the doctor, and at the same time, after end bending, the protective cover can still be used for end protection, so that the oral mucosa is isolated from the archwire, minimizing the impact of the archwire on the mucosa.

### BRIEF DESCRIPTION OF THE DRAWINGS

The present application will be described in detail in combination with the accompanying drawings and the specific embodiments.

FIG. 1 is an overall structural schematic diagram of a buccal tube according to the present invention.

FIG. 2 is a schematic diagram of a protective cover of the buccal tube in an open state according to the present invention.

FIG. 3 is an exploded structural schematic diagram of the buccal tube according to the present invention.

FIG. 4 is a further exploded schematic diagram of the buccal tube according to the present invention.

FIG. 5 is a structural schematic diagram of the protective cover of the buccal tube according to the present invention.

FIG. 6 is an exploded structural schematic diagram of the buccal tube along another direction according to the present invention.

FIG. 7 is an exploded structural schematic diagram of the buccal tube in a plane direction according to the present invention.

FIG. 8 is a structural schematic diagram of the protective cover of the buccal tube along another direction according to the present invention.

FIG. 9 is a structural schematic diagram of another embodiment of the buccal tube according to the present invention.

### DETAILED DESCRIPTION OF THE EMBODIMENTS

In order to make the technical means, the creation features, the objectives and the effects achieved by the present application easy to understand, the present application is further described below with reference to specific drawings.

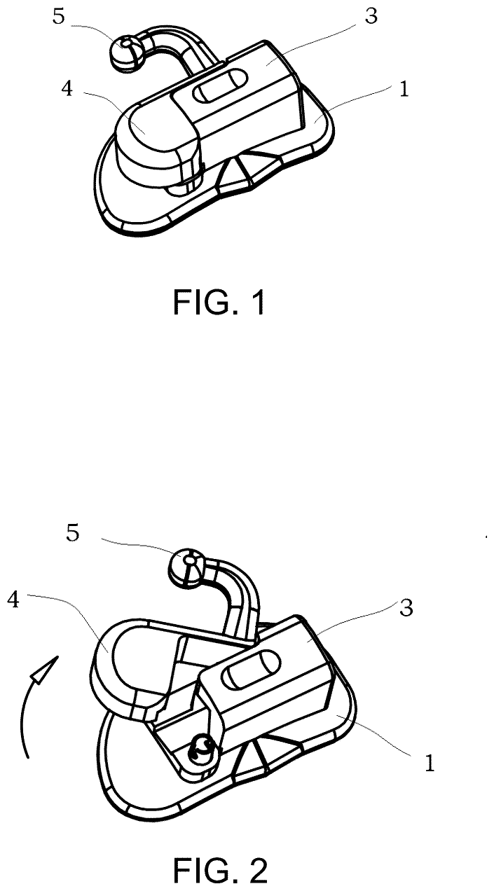

Embodiment 1: Referring to FIG. 1, the buccal tube is arranged on the last tooth at an end of an archwire. The buccal tube includes a base plate 1, and the base plate 1 is secured to the tooth in an adhesive manner when in use. A hollow archwire tube 3 for the archwire to pass through is arranged on the base plate 1. The archwire passes through the hollow archwire tube and is covered by a protective cover 4. The end of the archwire is fully covered by the protective cover 4, preventing the end of the archwire from coming into contact with the oral mucosa. A traction hook 5 is further arranged on the protective cover for being rotated and pulled to apply force to open the protective cover.

Referring to FIG. 2, the protective cover 4 is a turnable structure, a pivot is arranged on one side of the protective cover, and the protective cover is turned and moved around the pivot. The pivot is located on the base plate 1 or an outer wall of the hollow archwire tube 3.

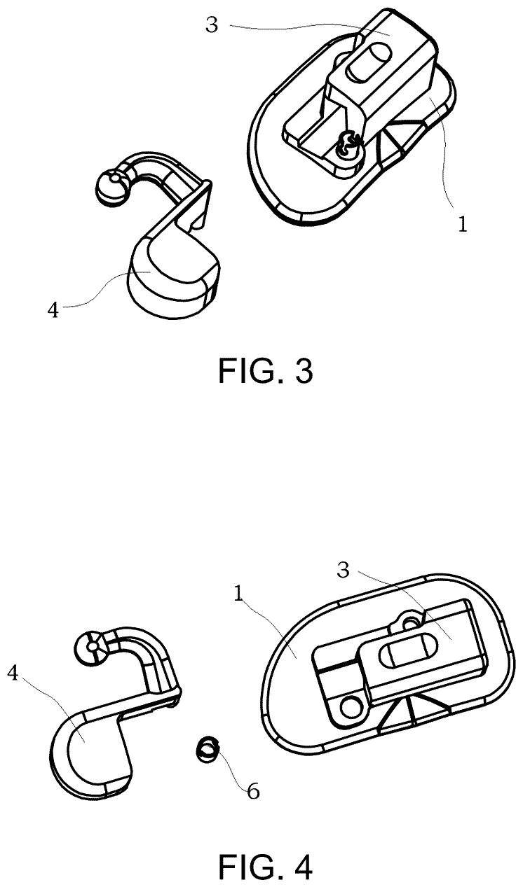

Referring to FIG. 3, the protective cover 4 is separated from the base plate 1, the protective cover 4 and the traction hook 5 are an integrated structure, the protective cover 4 is a semicircular closing cover that just closes over an end of the hollow archwire tube 3. The traction hook 5 is arranged on an upper side of the protective cover.

Referring to FIG. 4, the protective cover 4 is further separated from the base plate 1, the base plate 1 is provided with a clamping mechanism 6 for the closing of the protective cover 4, the clamping mechanism 6 includes a column-shaped part, and after the protective cover 4 is rotated to cover the hollow archwire tube 3, the protective cover is clamped by the clamping mechanism 6.

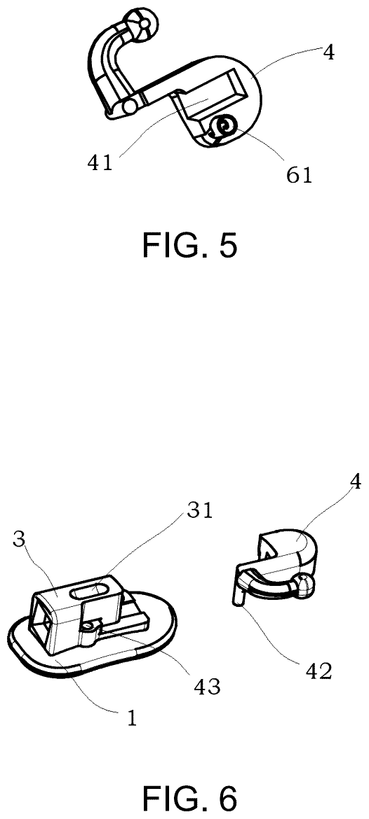

Referring to FIG. 5, the protective cover 4 is internally provided with a slot 41 for accommodating the archwire, and the archwire extending out of the hollow archwire tube 3 is arranged in the slot 41. A clamping groove 61 matched with the clamping mechanism 6 is further provided on an inner side of the protective cover 4, and when the protective cover 4 is closed, the clamping mechanism 6 is clamped in the clamping groove 61.

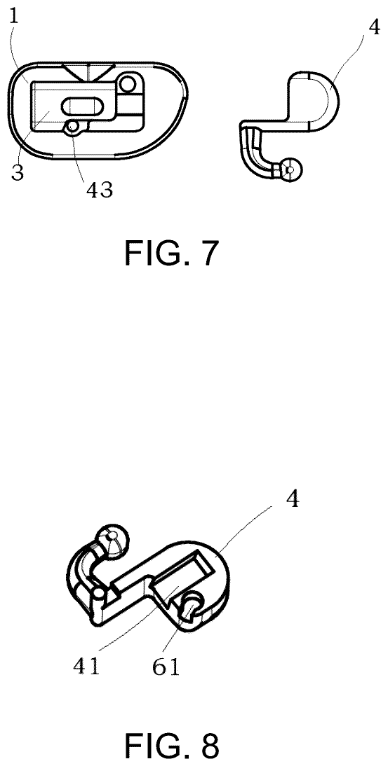

Referring to FIG. 6 and FIG. 7, the hollow archwire tube 3 is provided with a window 31, and the window 31 for observing the archwire inside. A shaft hole 43 is provided on an upper side of the hollow archwire tube, the protective cover 4 is provided with a pivot 42 inserted into the shaft hole 43, the pivot 42 is located at the root of the traction hook 5, and the protective cover 4 is rotated around the pivot 42 by toggling the traction hook 5, thus completing opening and closing actions. The pivot 42 is also located on an inner side of an upper part of the protective cover 4.

Referring to FIG. 8, the clamping groove 61 on the inner side of the protective cover 4 matched with the clamping mechanism 6 is Ω-shaped, the clamping groove 61 has a small opening and a big inner diameter, specifically, the size of the opening of the clamping groove 61 is smaller than the diameter of the clamping mechanism 6, and the inner size of the clamping groove 61 is greater than or equal to the diameter of the clamping mechanism 6.

When the buccal tube is mounted to a tooth of the patient, and after the archwire applies a force, the protective cover 4 is in a first state, at the moment, the protective cover 4 covers the end of the archwire passing through the hollow archwire tube 3, preventing the end of the archwire from coming into contact with the oral mucosa of the patient.

When the buccal tube is not mounted to the tooth of the patient, or before the archwire applies a force, the protective cover 4 is in a second state, and at the moment, the movement of the archwire in the hollow archwire tube 3 is not restricted by the protective cover 4.

Embodiment 2: The protective cover is a turnable structure, a pivot is arranged on a lower side of the protective cover, the traction hook is also arranged on the lower side of the protective cover, and the protective cover is turned and moved around the pivot. The pivot is located on the base plate. When covering the archwire, the protective cover is turned inwardly around the pivot from a left side.

Embodiment 3: The pivot is arranged on the lower side of the protective cover, the protective cover is turned and moved around the pivot from bottom to top, and the pivot is located on the base plate. When covering the archwire, the protective cover is turned upward around the pivot.

Embodiment 4: The pivot is arranged on the upper side of the protective cover, the protective cover is turned and moved around the pivot from top to bottom, and the pivot is located on the base plate. When covering the archwire, the protective cover is turned downward around the pivot.

Embodiment 5: The protective cover is a split structure without a rotating shaft. When not required, the protective cover is placed aside. When the buccal tube is mounted to the tooth of the patient, and after the archwire applies a force, the protective cover is in a first state, at the moment, the protective cover is taken out to cover the end of the archwire passing through the hollow archwire tube, preventing the end of the archwire from coming into contact with the oral mucosa of the patient.

Embodiment 6: When a plurality of archwires are used for orthodontic treatment, a plurality of protective covers are arranged behind the hollow archwire tube, each protective cover is used to cover an end of the corresponding archwire passing through, preventing the end of the archwire from coming into contact with the oral mucosa of the patient.

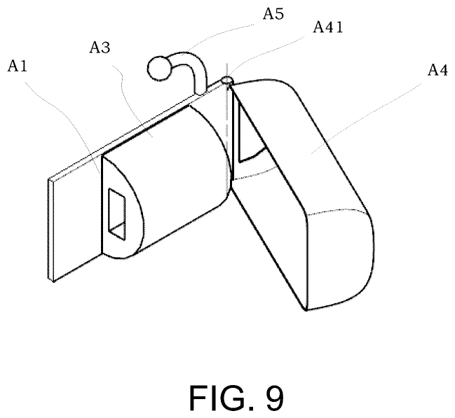

Embodiment 7: Referring to FIG. 9, the buccal tube is arranged on the last tooth at the end of the archwire. The buccal tube includes a base plate A1, and the base plate A1 is secured to the tooth in an adhesive manner when in use. A hollow archwire tube A3 for the archwire to pass through is arranged on the base plate A1. A protective cover A4 is arranged outside the hollow archwire tube A3, and the protective cover A4 covers the entire hollow archwire tube and the end of the archwire passing therethrough, preventing the end of the archwire from coming into contact with the oral mucosa. A traction hook A5 is further arranged on the base plate A1.

The protective cover A4 is a turnable structure, a pivot A41 is arranged on one side of the protective cover, and the protective cover is turned and moved around the pivot. The pivot A41 is located on the base plate A1. A hole for the archwire to pass through is formed in one side of the protective cover A4 close to the pivot, and the other side of the protective cover A4 is closed.

When the buccal tube is mounted to the tooth of the patient, and after the archwire applies a force, the protective cover A4 is in a first state, at the moment, the protective cover A4 covers the entire hollow archwire tube and the end of the archwire passing therethrough, preventing the end of the archwire from coming into contact with the oral mucosa of the patient.

When the buccal tube is not mounted to the tooth of the patient, or before the archwire applies a force, the protective cover 4 is in a second state, and at the moment, the archwire passes through the hollow archwire tube 3 without restriction.

The above description shows and describes the basic principle, main features and advantages of the present invention. It should be understood by those skilled in the art that the present application is not limited to the above examples. The above examples and descriptions in the specification are only illustrative of the principle of the present invention. Various changes and modifications may be made to the present application without departing from the spirit and scope of the present invention. These changes and modifications fall within the scope of protection of the present invention. The scope of the claimed protection of the present application is defined by the appended claims and their equivalents.

1. A buccal tube, comprising a base plate fixed to a surface of an orthodontic tooth, at least one hollow archwire tube for accommodating an archwire to pass through, and an archwire protection mechanism, wherein
when the buccal tube is mounted to the orthodontic tooth of a patient, the archwire protection mechanism is in a first state, the archwire protection mechanism covers an end of the archwire passing through the at least one hollow archwire tube, preventing the end of the archwire from contacting an oral mucosa of the patient; and
before the buccal tube is mounted to the orthodontic tooth of the patient, the archwire protection mechanism is in a second state, and a movement of the archwire in the at least one hollow archwire tube is not restricted by the archwire protection mechanism.

2. The buccal tube according to claim 1, further comprising a traction hook, which is arranged on the archwire protection mechanism.

3. The buccal tube according to claim 1, wherein a number of the at least one hollow archwire tube is more than one.

4. The buccal tube according to claim 1, wherein the archwire protection mechanism is a guard plate structure which is an openable and closable; when the archwire protection mechanism is in the second state, the guard plate structure is in an open state; and when the archwire protection mechanism is in the first state, the guard plate structure is in a closed state, and the guard plate structure covers the end of the archwire.

5. The buccal tube according to claim 4, wherein the guard plate structure does not have a rotating shaft, and an archwire protective cover directly covers the end of the archwire and is secured.

6. The buccal tube according to claim 2, wherein the archwire protection mechanism is a protective cover structure, and the protective cover structure is pivotally secured to an outer wall of the at least one hollow archwire tube or the base plate; when the archwire protection mechanism is in the second state, the protective cover structure is in an open state; and when the archwire protection mechanism is in the first state, the protective cover structure is in a closed state, and the protective cover structure covers the end of the archwire.

7. The buccal tube according to claim 6, wherein the protective cover structure is fixedly connected to the traction hook, and the protective cover structure and the traction hook are jointly and pivotally secured to the outer wall of the at least one hollow archwire tube or the base plate; when the protective cover structure is in the second state, the protective cover structure is in an open state, a proximal wall of the traction hook abuts against the at least one hollow archwire tube; when the archwire protection mechanism is in the first state, the protective cover structure is in a closed state, the protective cover structure covers the end of the archwire, and an end of the traction hook points to a distal side; and by toggling the traction hook, the archwire protection mechanism is switched between the first and second states.

8. The buccal tube according to claim 6, wherein the protective cover structure is pivotally rotated through a rotating shaft arranged vertically, and the archwire protective cover is opened and closed left and right around the rotating shaft.

9. The buccal tube according to claim 6, wherein the protective cover structure is pivotally rotated through a rotating shaft arranged horizontally, and the archwire protective cover is opened and closed up and down around the rotating shaft.

10. The buccal tube according to claim 7, wherein the protective cover structure and the traction hook are fixedly and integrally formed, and the protective cover structure is in a cap shape.

11. The buccal tube according to claim 6, wherein the protective cover structure is a structure that covers entire of the at least one hollow archwire tube and the end of the archwire passing therethrough.

12. The buccal tube according to claim 11, wherein a pivot is arranged on one side of the protective cover structure, the protective cover structure rotates around the pivot, the pivot is located on the base plate, a hole for the archwire to pass through is formed in one side of the protective cover structure close to the pivot, and an other side of the protective cover structure is closed.

13. A method for protecting end of archwire, comprising: providing an archwire protection mechanism on a buccal tube, wherein when the buccal tube is mounted to a tooth of a patient, the archwire protection mechanism is in a first state, the archwire protection mechanism covers an end of an archwire passing through a hollow archwire tube, preventing the end of the archwire from contacting an oral mucosa of the patient;
wherein before the buccal tube is mounted to the tooth of the patient, the archwire protection mechanism is in a second state, and a movement of the archwire in the hollow archwire tube is not restricted by the archwire protection mechanism.

14. The method for protecting end of archwire according to claim 13, wherein a pivot is arranged on one side of the archwire protection mechanism, the archwire protection mechanism rotates around the pivot, the pivot is located on a base plate, and a traction hook is further arranged on the archwire protection mechanism; and during usage, the traction hook is turned to enable the archwire protection mechanism to rotate around the pivot, thereby covering the end of the archwire.

15. The method for protecting end of archwire according to claim 13, wherein the archwire protection mechanism does not have a rotating shaft, and the archwire protection mechanism directly covers a base plate where the end of the archwire is located and is secured.
